(19) United States
(12) Patent Application Publication
(10) Pub. No.: US 2009/0091826 A1
(43) Pub. Date: Apr. 9, 2009

(54) POLARIZING PLATE AND IMAGE DISPLAY APPARATUS

(75) Inventor: Youichirou Sugino, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/995,872

(22) PCT Filed: Jul. 12, 2006
(86) PCT No.: PCT/JP2006/313835

§ 371 Date: Jan. 16, 2008

(30) Foreign Application Priority Data
Jul. 19, 2005 (JP) 2005-207992

(51) Int. Cl. G02B 1/08

(52) U.S. Cl. 359/500

(57) ABSTRACT

Provided are a polarizing plate with less defects of outer appearance, which is extremely excellent in an adhesiveness between a polarizer and a polarizer protective film in an environment of high temperature or high humidity and is also excellent in optical properties, and to which a conventional general-purpose adhesive layer can be applied, and an image display apparatus of high quality using the polarizing plate. The polarizing plate according to the present invention includes a polarizer formed of a polyvinyl alcohol-based resin, an adhesive layer, a metal salt layer, and a polarizer protective film in the stated order.

### TECHNICAL FIELD

The present invention relates to a polarizing plate and an image display apparatus such as a liquid crystal display apparatus, an organic EL display apparatus, or a PDP including at least one polarizing plate.

### BACKGROUND ART

A liquid crystal display apparatus must have polarizing plates arranged on both sides of a glass substrate forming the surface of a liquid crystal panel due to its image forming system. An example of such a polarizing plate to be used is generally produced by attaching a polarizer protective film formed of triacetyl cellulose or the like on each side of a polarizer made of a polyvinyl alcohol-based film and a dichromatic substance such as iodine by using a polyvinyl alcohol-based adhesive.

Recently, the opportunity to use a liquid crystal display apparatus under high temperature or high humidity outside of a room as in a mobile terminal, a car navigation system, or the like is increasing. Thus, there is a demand for the development of a polarizing plate excellent in heat resistance and moisture resistance.

Triacetyl cellulose has insufficient heat and humidity resistance and thus has a problem in that properties such as a degree of polarization and a hue of a polarizing plate degrade when a polarizing plate using a triacetyl cellulose film as a polarizer protective film is used under high temperature or high humidity conditions. Further, a triacetyl cellulose film causes retardation with respect to incident light in an oblique direction. With recent increase in size of a liquid crystal display, the retardation have significant effects on viewing angle properties.

A transparent thermoplastic resin has been considered as a material for a polarizer protective film that replaces conventional triacetyl cellulose. In particular, (meth)acrylic resins such as acrylic esters and methacrylic esters have been considered since the (meth)acrylic resins are excellent in optical transparency and are also relatively excellent in heat resistance and moisture resistance.

However, in the case where a conventional polarizing plate is placed in an environment of high temperature or high humidity, there is a problem that a polarizer and a polarizer protective film are likely to peel off from each other due to the large decrease in adhesiveness therebetween, and optical properties degrade.

As one measure of improving the adhesiveness between the polarizer and the polarizer protective film in an environment of high temperature or high humidity, a technology of using a polyvinyl alcohol-based adhesive containing glyoxal and zinc chloride has been reported (see Patent Document 1). However, the adhesiveness between the polarizer and the polarizer protective film in an environment of high temperature or high humidity is not still sufficient. Further, the polyvinyl alcohol-based adhesive that has been generally used conventionally cannot be used as it is, which decreases the production efficiency.

### Patent Document: JP 7-134212 A

### DISCLOSURE OF THE INVENTION

### Problems to be Solved by the Invention

The present invention has been made in view of solving conventional problems as described above, and an object of the present invention is to provide: (1) a polarizing plate with less defects of outer appearance, which is extremely excellent in the adhesiveness between a polarizer and a polarizer protective film in an environment of high temperature or high humidity and is also excellent in optical properties, and to which a conventional general-purpose adhesive layer can be applied; and (2) an image display apparatus of high quality using such a polarizing plate.

### Means for Solving the Problems

A polarizing plate according to the present invention includes a polarizer formed of a polyvinyl alcohol-based resin, an adhesive layer, a metal salt layer, and a polarizer protective film in this order.

In the polarizing plate according to a preferred embodiment of the present invention, the adhesive layer is formed of a polyvinyl alcohol-based adhesive.

In the polarizing plate according to a preferred embodiment of the present invention, the metal salt layer is formed of at least one kind selected from a zinc salt and a cobalt salt.

In the polarizing plate according to a preferred embodiment of the present invention, the polarizer protective film contains a (meth)acrylic resin layer.

The polarizing plate according to a preferred embodiment of the present invention further includes as at least one of an outermost layer a pressure-sensitive adhesive layer.

According to another aspect of the present invention, an image display apparatus is provided. The image display apparatus of the present invention includes at least one of the polarizing plate of the present invention.

### Effects of the Invention

According to the present invention, a polarizing plate with less defects of outer appearance can be provided, which is extremely excellent in the adhesiveness between a polarizer and a polarizer protective film in an environment of high temperature or high humidity and is also excellent in optical properties, and to which a conventional general-purpose adhesive layer can be applied. Further, an image display apparatus of high quality using such a polarizing plate can be provided.

The polarizing plate and the image display apparatus of the present invention are excellent in heat resistance and moisture resistance, as well as optical properties. Therefore, the polarizing plate and the image display apparatus of the present invention are preferred for the use under high temperature or high humidity outside of a room as in a mobile terminal, a car navigation system, or the like, as well as the general use.

### BRIEF DESCRIPTION OF THE DRAWINGS

FIG. 1A cross-sectional view showing an example of a polarizing plate of the present invention.

FIG. 2A schematic cross-sectional view of a liquid crystal display apparatus according to a preferred embodiment of the present invention.

### DESCRIPTION OF REFERENCE NUMERALS

10 liquid crystal cell
11, 11′ glass substrate
12 liquid crystal layer
13 spacer
20, 20′ retardation film
30, 30′ polarizing plate
31 polarizer
32 adhesive layer
33 easy-adhesive layer
34 metal salt layer
35 polarizer protective film
36 adhesive layer
37 polarizer protective film
40 light guiding plate
50 light source
60 reflector
100 liquid crystal display apparatus

### BEST MODE FOR CARRYING OUT THE INVENTION

Hereinafter, description will be given of preferred embodiments of the present invention, but the present invention is not limited to the embodiments.

### [Polarizer Protective Film]

The polarizer protective film in the present invention may be a film containing a resin layer with high optical transparency without any particular limit. Examples of the polarizer protective film include a film containing a layer formed of a cellulose-based resin (cellulose-based resin layer), and a film containing a layer formed of a (meth)acrylic resin ((meth)acrylic resin layer). The polarizer protective film in the present invention may be formed of a film made of a single layer or a film made of at least two layers. The polarizer protective film in the present invention preferably contains a (meth)acrylic resin layer.

The above-mentioned cellulose-based resin is not particularly limited, but triacetyl cellulose is preferred in terms of transparency and adhesiveness.

Although not particularly limited, examples of the aforementioned (meth)acrylic resin include a poly(meth)acrylic ester such as polymethylmethacrylate, a methyl methacrylate-(meth)acrylic acid copolymer, a methyl methacrylate-(meth)acrylic ester copolymer, a methyl methacrylate-acrylic ester-(meth)acrylic acid copolymer, a methyl (meth)acrylate-styrene copolymer (MS resin, etc.), and a polymer having an alicyclic hydrocarbon group (e.g., a methyl methacrylate-cyclohexyl methacrylate copolymer, a methyl methacrylate-norbornyl (meth)acrylate copolymer, etc.). The (meth)acrylic resin is preferably a poly(meth)acrylic C₁₋₆ alkyl such as methyl poly(meth)acrylate, and in particular, preferably methyl methacrylate-based resin containing as a main component methyl methacrylate (50 to 100% by weight, preferably 70 to 100% by weight).

The above (meth)acrylic resin has a Tg (glass transition temperature) of preferably 120° C. or more, more preferably 125° C. or more, and still more preferably 130° C. or more. In the case where the polarizer protective film contains as a main component the above (meth)acrylic resin having a Tg (glass transition temperature) of 120° C. or more, for example, when the polarizer protective film is incorporated in a polarizing plate finally, the durability is likely to be excellent. The upper limit value of Tg of the above (meth)acrylic resin is preferably 300° C. or less, more preferably 290° C. or less, and still more preferably 285° C. or less in terms of the formability and the like, although not particularly limited.

Specific examples of the above (meth)acrylic resin include ACRYPET VH and ACRYPET VRL20A manufactured by Mitsubishi Rayon Co., Ltd., a (meth)acrylic resin, in which the (meth)acrylic compound has a ring structure in the molecule, described in JP 2004-70296 A, and a high Tg (meth)acrylic resin obtained by intramolecular cross-linking or intramolecular cyclization reaction. Examples of the above (meth)acrylic resin also include (meth)acrylic resins each having a lactone ring structure described in JP 2002-120326 A and JP 2002-254544 A.

The above (meth)acrylic resin preferably has a high light transmittance, and low in-plane retardation And thickness direction retardation Rth.

The thickness of the polarizer protective film of the present invention is preferably 20 to 200 μm, more preferably 25 to 180 μm, and further more preferably 30 to 140 μm. When the thickness of the polarizer protective film is 20 μm or more, the polarizer protective film has appropriate strength and stiffness, and offers excellent handleability during secondary processing such as lamination and printing. Further, with such a thickness, the retardation resulting from the stress during withdrawing can be easily controlled, and thus, a film can be produced stably and easily. When the thickness of the polarizer protective film is 200 μm or less, the take-up of a film is easy, and a line speed, productivity, and controllability are improved.

In the case where the polarizer protective film in the present invention contains a (meth)acrylic resin, the content of the (meth)acrylic resin in the polarizer protective film is preferably 50 to 99% by weight, more preferably 60 to 98% by weight, and still more preferably 70 to 97% by weight. In the case where the content of the (meth)acrylic resin in the polarizer protective film is less than 50% by weight, there is a possibility that the high heat resistance and high transparency, which the (meth)acrylic resin originally has, cannot be reflected sufficiently. In the case where the content of the (meth)acrylic resin in the polarizer protective film exceeds 99% by weight, the mechanical strength of the polarizer protective film may be degraded.

The polarizer protective film in the present invention may contain a UV-absorber and general compounding agents such as a stabilizer, a lubricant, a processing aid, a plasticizer, a shock resistance assistant, a retardation reducer, a flatting agent, an antibacterial agent, and a fungicide.

YI in a thickness of 80 μm of the polarizer protective film in the present invention is preferably 1.3 or less, more preferably 1.27 or less, still more preferably 1.25or less, much more preferably 1.23 or less, and particularly preferably 1.20 or less. When YI in the thickness of 80 μm exceeds 1.3, excellent optical transparency may not be exhibited. YI can be obtained, for example, by the following expression based on tristimulus values (X, Y, Z) of a color obtained by a measurement, using a high-speed integrating-sphere spectral transmittance meter (DOT-3C (Trade name), manufactured by Murakami Color Research Laboratory Instruments).

YI=[(1.28X−1.06Z)/Y]×100

A b-value (scale of a hue in accordance with a Hunter-color system) in a thickness of 80 μm of the polarizer protective film in the present invention is preferably less than 1.5, and more preferably 1.0 or less. In the case where the b-value is 1.5 or more, excellent optical transparency may not be exhibited due to the coloring of a film. The b-value can be obtained, for example, by cutting a polarizer protective film sample into 3 cm per side and measuring the hue thereof using the high-speed integrating-sphere spectral transmittance meter (DOT-3C (Trade name), manufactured by Murakami Color Research Laboratory Instruments). The hue can be evaluated based on a b-value in accordance with the Hunter-color system.

In the polarizer protective film of the present invention, the in-plane retardation And is preferably 3.0 nm or less, and more preferably 1.0 nm or less. When the aforementioned in-plane retardation And exceeds 3.0 nm, there is a possibility that the effects of the present invention, in particular, excellent optical properties may not be exhibited. The thickness direction retardation Rth is preferably 5.0 nm or less, and more preferably nm or less. When the aforementioned thickness direction retardation Rth exceeds 5.0 nm, the effects of the present invention, in particular, excellent optical properties may not be exhibited. In the polarizer protective film in the present invention, the moisture permeability is preferably 100 g m²·24 hr or less, and more preferably 60 g/m²·24 hr or less. When the above moisture transparency exceeds 100 g/m²·24 hr, the moisture resistance may be degraded.

It is preferred that the polarizer protective film in the present invention also have excellent mechanical strength. The tensile strength in an MD direction is preferably 65 N/mm² or more, more preferably 70 N/mm² or more, still more preferably 75 N/mm² or more, and particularly preferably 80N/mm² or more, and the tensile strength in a TD direction is preferably 45 N/mm² or more, more preferably 50 N/mm² or more, still more preferably 55 N/mm² or more, and particularly preferably 60N/mm² or more. The tensile elongation in the MD direction is preferably 6.5% or more, more preferably 7.0% or more, still more preferably 7.5% or more, and particularly preferably 8.0% or more, and the tensile elongation in the TD direction is preferably 5.0% or more, more preferably 5.5% or more, still preferably 6.0% or more, and particularly preferably 6.5% or more. In the case where the tensile strength or the tensile elongation are out of the above ranges, excellent mechanical strength may not be exhibited.

The haze representing optical transparency of the polarizer protective film in the present invention is desirably as low as possible, and is preferably 5% or less, more preferably 3% or less, still more preferably 1.5% or less, and particularly preferably 1% or less. When the haze is 5% or less, the film can be provided with a clear feeling visually. When the haze is 1.5% or less, even if the film is used as a lighting member such as a window, visibility and a lighting property are both obtained, and even if the film is used as a front plate of a display apparatus, display contents can be satisfactorily recognized visually. Therefore, the industrial use value of the film is high.

The polarizer protective film of the present invention may be manufactured by any method, but it is preferred to use a method of producing the polarizer protective film by subjecting a resin composition for forming an unstretched film to extrusion (melt extrusion such as a T-die method or an inflation method), casting (melt casting, etc.), or calendaring.

In the extrusion, it is not necessary to dry and scatter a solvent in an adhesive used during processing, e.g., an organic solvent in an adhesive for dry lamination or to perform a solvent drying step, and thus the extrusion is excellent in productivity. As a specific example, there is a method of forming a film by supplying a resin composition as a material to an extruder connected to a T-die, followed by melt kneading, extrusion, water-cooling, and withdrawing. The extruder may be of a single or twin screw type, and an additive such as a plasticizer or an antioxidant may be added.

The temperature for extrusion can be set appropriately, when the glass transition temperature of a resin composition as a material is Tg(° C.), (Tg+80)° C. to (Tg+180)° C. is preferred, and (Tg+100)° C. to (Tg+150)° C. is more preferred. When the temperature for extrusion is too low, a resin may not be formed due to lack of flowability. When the temperature for extrusion is too high, the viscosity of a resin becomes low, which may cause a problem in production stability such as non-uniform thickness of a formed product.

The resin composition forming the polarizer protective film in the present invention may contain a UV-absorber, and general compounding agents such as a stabilizer, a lubricant, a processing aid, a plasticizer, a shock resistance assistant, a retardation reducer, a flatting agent, an antibacterial agent, and a fungicide.

As the optical properties of the polarizer protective film, the magnitude of the retardations in front and thickness directions become significant. Therefore, it is preferred that the resin composition forming the polarizer protective film in the present invention contain a retardation reducer. As the retardation reducer, for example, styrene-containing polymers such as an acrylonitrile-styrene block copolymer and an acrylonitrile-styrene block copolymer are preferred. The adding amount of the retardation reducer is preferably 30% by weight or less, more preferably 25% by weight or less, and still more preferably 20% by weight or less with respect to the (meth)acrylic resin. The addition of the retardation reducer in an amount exceeding the range may scatter visible light and impair transparency, so the polarizer protective film may lack properties thereof.

The polarizer protective film of the present invention can be laminated onto another base. For example, the polarizer protective film of the present invention can also be laminated onto a base made of glass, a polyolefin resin, an ethylene-vinylidene copolymer to be a high barrier layer, polyester, or the like by multilayer extrusion or multilayer inflation including an adhesive resin layer. In a case where thermal adhesiveness is high, an adhesion layer may be omitted.

The polarizer protective film of the present invention can be used by being laminated onto, for example, a lighting member for construction, such as a window and a carport roof member, a lighting member for a vehicle, such as a window, a lighting member for agriculture, such as a greenhouse, an illumination member, a display member such as a front filter, or the like, in addition to the application to the protection of a polarizer. Further, the polarizer protective film of the present invention can also be used by being laminated onto a package of consumer electronics, an interior member in a vehicle, a construction material for an interior, a wall paper, a decorative laminate, a hallway door, a window frame, a foot stall, and the like, which are covered with a (meth)acrylic resin film conventionally.

### [Polarizing Plate]

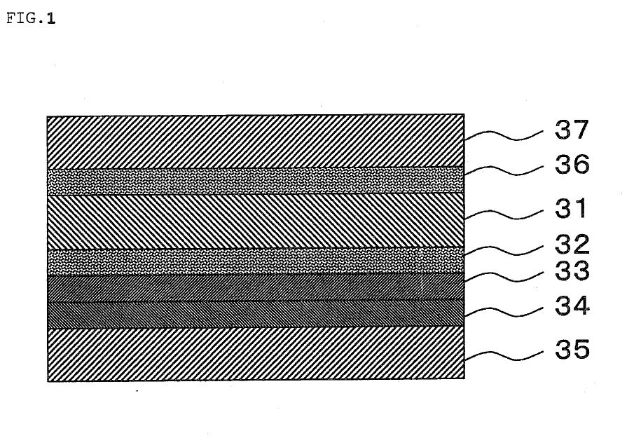

The polarizing plate of the present invention has a polarizer formed of a polyvinyl alcohol-based resin, an adhesive layer, a metal salt layer, and a polarizer protective film in the stated order. As shown in FIG. 1, one preferred embodiment of the polarizing plate of the present invention is that one surface of a polarizer 31 is attached to a polarizer protective film 35 via an adhesive layer 32, an easy-adhesive layer 33, and a metal salt layer 34, and the other surface of the polarizer 31 is attached to a polarizer protective film 37 via an adhesive layer 36. An easy-adhesive layer may be present between the adhesive layer 36 and the polarizer protective film 37.

The polarizer formed of a polyvinyl alcohol-based resin is generally manufactured by: coloring a polyvinyl alcohol-based resin film with a dichromatic substance (typically, iodine or a dichromatic dye); and uniaxially stretching the film. The degree of polymerization of the polyvinyl alcohol-based resin for forming the polyvinyl alcohol-based resin film is preferably 100 to 5,000, and more preferably 1,400 to 4,000. The polyvinyl alcohol-based resin film for forming the polarizer may be formed by any appropriate method (such as a flow casting method involving film formation through flow casting of a solution containing a resin dissolved in water or an organic solvent, a casting method, or an extrusion method). The thickness of the polarizer may be appropriately set in accordance with the purpose and application of LCD employing the polarizing plate, but is typically 5 to 80 μm.

For producing a polarizer, any appropriate method may be employed in accordance with the purpose, materials to be used, conditions, and the like. Typically, employed is a method in which the polyvinyl alcohol-based resin film is subjected to a series of production steps including swelling, coloring, cross-linking, stretching, water washing, and drying steps. In each of the treatment steps excluding the drying step, the polyvinyl alcohol-based resin film is immersed in a bath containing a solution to be used in each step. The order, number of times, and absence or presence of swelling, coloring, cross-linking, stretching, water washing, and drying steps may be appropriately set in accordance with the purpose, materials to be used, conditions, and the like. For example, several treatments may be conducted at the same time in one step, or specific treatments may be omitted. More specifically, stretching treatment, for example, may be conducted after coloring treatment, before coloring treatment, or at the same time as swelling treatment, coloring treatment, and cross-linking treatment. Further, for example, cross-linking treatment can be preferably conducted before and after stretching treatment. Further, for example, water washing treatment may be conducted after each treatment or only after specific treatments.

The swelling step is typically conducted by immersing the polyvinyl alcohol-based resin film in a treatment bath (swelling bath) filled with water. This treatment allows washing away of contaminants from a surface of the polyvinyl alcohol-based resin film, washing away of an anti-blocking agent, and swelling of the polyvinyl alcohol-based resin film, to thereby prevent non-uniformity such as uneven coloring. The swelling bath may appropriately contain glycerin, potassium iodide, or the like. The temperature of the swelling bath is typically about 20 to 60° C., and the immersion time in the swelling bath is typically about 0.1 to 10 minutes.

The coloring step is typically conducted by immersing the polyvinyl alcohol-based resin film in a treatment bath (coloring bath) containing a dichromatic substance such as iodine. As a solvent to be used for a solution of the coloring bath, water is generally used, but an appropriate amount of an organic solvent having compatibility with water may be added. The dichromatic substance is typically used in a ratio of 0.1 to 1.0 part by weight with respect to 100 parts by weight of the solvent. In the case where iodine is used as a dichromatic substance, the solution of the coloring bath preferably further contains an assistant such as an iodide for improving a coloring efficiency. The assistant is used in a ratio of preferably 0.02 to 20 parts by weight, and more preferably 2 to 10 parts by weight with respect to 100 parts by weight of the solvent. Specific examples of the iodide include potassium iodide, lithium iodide, sodium iodide, zinc iodide, aluminum iodide, lead iodide, copper iodide, barium iodide, calcium iodide, tin iodide, and titanium iodide. The temperature of the coloring bath is typically about 20 to 70° C., and the immersion time in the coloring bath is typically about 1 to 20 minutes.

The cross-linking step is typically conducted by immersing in a treatment bath (cross-linking bath) containing a cross-linking agent the polyvinyl alcohol-based resin film that has undergone the coloring treatment. The cross-linking agent employed may be any appropriate cross-linking agent. Specific examples of the cross-linking agent include: a boron compound such as boric acid or borax; glyoxal; and glutaraldehyde. The cross-linking agent may be used alone or in combination. As a solvent to be used for a solution of the cross-linking bath, water is generally used, but an appropriate amount of an organic solvent having compatibility with water may be added. The cross-linking agent is typically used in a ratio of 1 to 10 parts by weight with respect to 100 parts by weight of the solvent. In the case where a concentration of the cross-linking agent is less than 1 part by weight, sufficient optical properties are often not obtained. In the case where the concentration of the cross-linking agent is more than 10 parts by weight, stretching force to be generated on the film during stretching increases and a polarizing plate to be obtained may shrink. The solution of the cross-linking bath preferably further contains an assistant such as an iodide for obtaining uniform properties in the same plane. The concentration of the assistant is preferably 0.05 to 15 wt %, and more preferably 0.5 to 8 wt %. Specific examples of the iodide are the same as in the case of the coloring step. The temperature of the cross-linking bath is typically about 20 to 70° C., and preferably 40 to 60° C. The immersion time in the cross-linking bath is typically about 1 second to 15 minutes, and preferably 5 seconds to 10 minutes.

The stretching step may be conducted at any stage as described above. Specifically, the stretching step may be conducted after the coloring treatment, before the coloring treatment, at the same time as the swelling treatment, the coloring treatment, and the cross-linking treatment, or after the cross-linking treatment. A cumulative stretching ratio of the polyvinyl alcohol-based resin film must be 5 times or more, preferably 5 to 7 times, and more preferably 5 to 6.5 times. In the case where the cumulative stretching ratio is less than 5 times, a polarizing plate having a high degree of polarization may be hard to obtain. In the case where the cumulative stretching ratio is more than 7 times, the polyvinyl alcohol-based resin film (polarizer) may easily break. A specific method of stretching employed may be any appropriate method. For example, in the case where a wet stretching method is employed, a polyvinyl alcohol-based resin film is stretched in a treatment bath (stretching bath) to a predetermined ratio. A solution of the stretching bath to be preferably used is a solution in which various metal salts or compounds of iodine, boron, or zinc are added to a solvent such as water or an organic solvent (such as ethanol).

The water washing step is typically conduced by immersing in a treatment bath (water washing bath) the polyvinyl alcohol-based resin film that has undergone the various treatments. The water washing step allows washing away of unnecessary remains from the polyvinyl alcohol-based resin film. The water washing bath may contain pure water or an aqueous solution containing iodide (such as potassium iodide or sodium iodide). The concentration of an aqueous iodide solution is preferably 0.1 to 10% by weight. The aqueous iodide solution may contain an assistant such as zinc sulfate or zinc chloride. The temperature of the water washing bath is preferably 10 to 60° C., and more preferably 30 to 40° C., and the immersion time is typically 1 second to 1 minute. The water washing step may be conducted only once, or may be conducted a plurality of times as required. In the case where the water washing step is conducted a plurality of times, the kind and concentration of the additive contained in the water washing bath to be used for each treatment may appropriately be adjusted. For example, the water washing step includes a step of immersing a polymer film in an aqueous potassium iodide solution (0.1 to 10% by weight, 10 to 60° C.) and a step of washing the polymer film with pure water.

The drying step may employ any appropriate drying method (such as natural drying, air drying, or heat drying). For example, in heat drying, a drying temperature is typically 20 to 80° C., and a drying time is typically 1 to 10 minutes. In such a manner as described above, the polarizer is obtained.

The polarizing plate of the present invention has an adhesive layer between the above polarizer protective film and the polarizer.

In the present invention, it is preferred that the adhesive layer be a layer formed of a polyvinyl alcohol-based adhesive. The polyvinyl alcohol-based adhesive preferably contains a polyvinyl alcohol-based resin and a cross-linking agent.

Examples of the above-mentioned polyvinyl alcohol-based resin include without particular limitation: a polyvinyl alcohol obtained by saponifying polyvinyl acetate; derivatives thereof; a saponified product of a copolymer obtained by copolymerizing vinyl acetate with a monomer having copolymerizability with vinyl acetate; and a modified polyvinyl alcohol obtained by modifying polyvinyl alcohol to acetal, urethane, ether, graft polymer, phosphate, or the like. Examples of the monomer include: unsaturated carboxylic acids such as maleic acid (anhydrides), fumaric acid, crotonic acid, itaconic acid, and (meth)acrylic acid and esters thereof; α-olefin such as ethylene and propylene; (sodium) (meth)allylsulfonate; sodium sulfonate (monoalkylmalate); sodium disulfonate alkylmalate; N-methylol acrylamide; alkali salts of acrylamide alkylsulfonate; N-vinylpyrrolidone; and derivatives of N-vinylpyrrolidone. The polyvinyl alcohol-based resins may be used alone or in combination.

The polyvinyl alcohol-based resin has an average degree of polymerization of preferably 100 to 3,000, and more preferably 500 to 3,000, and an average degree of saponification of preferably to 100 mol %, and more preferably 90 to 100 mol %.

A polyvinyl alcohol-based resin having an acetoacetyl group may be used as the above-mentioned polyvinyl alcohol-based resin. The polyvinyl alcohol-based resin having an acetoacetyl group is a polyvinyl alcohol-based adhesive having a highly reactive functional group and is preferred from the viewpoint of improving durability of a polarizing plate.

The polyvinyl alcohol-based resin having an acetoacetyl group is obtained in a reaction between the polyvinyl alcohol-based resin and diketene through a known method. Examples of the known method include: a method involving dispersing the polyvinyl alcohol-based resin in a solvent such as acetic acid, and adding diketene thereto; and a method involving dissolving the polyvinyl alcohol-based resin in a solvent such as dimethylformamide or dioxane, in advance, and adding diketene thereto. Another example of the known method is a method involving directly bringing diketene gas or a liquid diketene into contact with polyvinyl alcohol.

A degree of acetoacetyl modification of the polyvinyl alcohol-based resin having an acetoacetyl group is not particularly limited as long as it is 0.1 mol % or more. A degree of acetoacetyl modification of less than 0.1 mol % provides insufficient water resistance with the adhesive layer and is inappropriate. The degree of acetoacetyl modification is preferably 0.1 to 40 mol %, and more preferably 1 to 20 mol %. A degree of acetoacetyl modification of more than 40 mol % decreases the number of reaction sites with a cross-linking agent and provides a small effect of improving the water resistance. The degree of acetoacetyl modification is a value measured by NMR.

As the above-mentioned cross-linking agent, the one used for a polyvinyl alcohol-based adhesive can be used without particular limitation. A compound having at least two functional groups each having reactivity with a polyvinyl alcohol-based resin can be used as the cross-linking agent. Examples of the compound include: alkylene diamines having an alkylene group and two amino groups such as ethylene diamine, triethylene amine, and hexamethylene dimamine (of those, hexamethylene diamine is preferred); isocyanates such as tolylene diisocyanate, hydrogenated tolylene diisocyanate, a trimethylene propane tolylene diisocyanate adduct, triphenylmethane triisocyanate, methylene bis(4-phenylmethanetriisocyanate, isophorone diisocyanate, and ketoxime blocked compounds and phenol blocked compounds thereof; epoxies such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino-formaldehyde resin such as a condensate of formaldehyde with methylol urea, methylol melamine, alkylated methylol urea, alkylated methylol melamine, acetoguanamine, or benzoguanamine; and salts of divalent or trivalent metals such as sodium, potassium, magnesium, calcium, aluminum, iron, and nickel and oxides thereof. A melamine-based cross-linking agent is preferred as the cross-linking agent, and methylolmelamine is particularly preferred.

A mixing amount of the cross-linking agent is preferably 0.1 to 35 parts by weight, and more preferably 10 to 25 parts by weight with respect to 100 parts by weight of the polyvinyl alcohol-based resin. Meanwhile, for improving the durability, the cross-linking agent may be mixed within a range of more than 30 parts by weight and 46 parts by weight or less with respect to 100 parts by weight of the polyvinyl alcohol-based resin. In particular, in the case where the polyvinyl alcohol-based resin having an acetoacetyl group is used, the cross-linking agent is preferably used in an amount of more than 30 parts by weight. The cross-linking agent is mixed within a range of more than 30 parts by weight and 46 parts by weight or less, to thereby improve the water resistance.

The above-mentioned polyvinyl alcohol-based adhesive can also contain a coupling agent such as a silane coupling agent or a titanium coupling agent, various kinds of tackifiers, a UV absorber, an antioxidant, a stabilizer such as a heat-resistant stabilizer or a hydrolysis-resistant stabilizer.

The metal salt layer included in the polarizing plate of the present invention is not particularly limited as long as the metal salt layer is a layer formed of at least one kind of metal salt. Examples of the metal salt include an iron salt, a cobalt salt, a nickel salt, a copper salt, and a zinc salt. It is preferred that the metal salt layer be formed of at least one kind selected from a zinc salt and a cobalt salt.

Examples of the zinc salt include zinc chloride and zinc sulfate.

Examples of the cobalt salt include cobalt chloride and cobalt sulfate.

The thickness of the metal salt layer is preferably 5 to 150 nm, more preferably 10 to 100 nm, and still more preferably 30 to 70 nm.

The metal salt layer can be formed by any suitable method. One preferred embodiment is a method of applying an aqueous solution containing at least one kind of a metal salt to a polarizer protective film, followed by drying.

When the metal salt layer is formed on the polarizer protective film, the surface of the polarizer protective film on which the metal salt layer is to be formed is preferably subjected to an easy-adhesion treatment such as a corona treatment, a plasma treatment, a low-pressure UV treatment, or a saponification treatment. Of those, it is more preferred that the corona treatment be conducted.

The polarizing plate of the present invention includes a metal salt layer between the polarizer protective film and the adhesive layer. Therefore, it is conceivable that the reaction between a functional group included in the polarizer protective film and metal and the reaction between the adhesive layer and metal occur, and the very excellent adhesiveness can be expressed between the polarizer and the polarizer protective film.

An easy-adhesive layer can be formed on a surface side of the polarizer protective film in the present invention to be in contact with the polarizer so as to enhance the adhesiveness. In the case where the polarizer protective film has the metal salt layer thereon, an easy-adhesive layer may be formed on the metal salt layer.

Examples of the above easy-adhesive layer include a silicone layer having a reactive functional group. The material for the silicone layer having a reactive functional group is not particularly limited, and examples thereof include alkoxysilanols containing an isocyanate group, alkoxysilanols containing an amino group, alkoxysilnaols containing a mercapto group, alkoxysilanols containing a carboxyl group, alkoxysilanols containing an epoxy group, alkoxysilnaols containing a vinyl-type unsaturated group, alkoxysilanols containing a halogen group, and alkoxysilanols containing an isocyanate group, and an amino-based silanol is preferred. Further, by adding a titanium-based catalyst and a tin-based catalyst for allowing the above silanol to be reacted efficiently, the adhesive strength can be increased. Further, other additives may be added to silicone having the above reactive functional group. Specifically, a tackifier such as a terpene resin, a phenol resin, a terpene-phenol resin, a rosin resin, and a xylene resin, a UV-absorber, an antioxidant, and a stabilizer such as a heat resistant stabilizer may be used.

The above-mentioned silicone layer having a reactive functional group is formed by coating and drying by a known technology. The thickness of the silicone layer after drying is preferably 1 to 100 nm and more preferably 10 to 50 nm. During coating, silicone having a reactive functional group may be diluted with a solvent. An example of a dilution solvent is not particularly limited but includes alcohols. The dilution concentration is not particularly limited but is preferably 1 to 5% by weight, and more preferably 1 to 3% by weight.

The above-mentioned adhesive layer is formed by applying the above-mentioned adhesive on either side or both sides of a polarizer protective film, and on either side or both sides of a polarizer. After the polarizer protective film and the polarizer are attached to each other, a drying step is performed, to thereby form an adhesive layer made of an applied dry layer. After the adhesive layer is formed, the polarizer and the polarizer protective film may also be attached to each other. The polarizer and the polarizer protective film are attached to each other with a roll laminator or the like. The heat-drying temperature and the drying time are appropriately determined depending upon the kind of an adhesive.

Too large thickness of the adhesive layer after drying is not preferred in view of the adhesive property of the polarizer protective film. Therefore, the thickness of the adhesive layer is preferably to 10 μm, and more preferably 0.03 to 5 μm.

The attachment of the polarizer protective film to the polarizer can be performed by bonding one side of the polarizer protective film on both sides of the polarizer.

Further, the attachment of the polarizer protective film to the polarizer can be performed by bonding one side of the polarizer protective film to one surface of the polarizer and attaching a cellulose-based resin to the other surface of the polarizer.

The cellulose-based resin is not particularly limited. However, triacetyl cellulose is preferred in terms of transparency and an adhesive property. The thickness of the cellulose-based resin is preferably 30 to 100 μm, and more preferably 40 to 80 μm. When the thickness is smaller than 30 μm, the film strength decreases to degrade workability, and when the thickness is larger than 100 μm, the light transmittance decreases remarkably in terms of durability.

The polarizing plate according to the present invention may have a pressure-sensitive adhesive layer as at least one of an outermost layer (such a polarizing plate may be referred to as polarizing plate of a pressure-sensitive adhesion type). As a particularly preferred embodiment, a pressure-sensitive adhesive layer for bonding of other members such as another optical film and a liquid crystal cell can be provided to an opposite side of the polarizer of the above-mentioned polarizer protective film.

The pressure-sensitive adhesive forming the above-mentioned pressure-sensitive adhesive layer is not particularly limited. However, for example, a pressure-sensitive adhesive containing as a base polymer an acrylic polymer, a silicone-based polymer, polyester, polyurethane, polyamide, polyether, a fluorine or rubber-based polymer can be appropriately selected to be used. In particular, a pressure-sensitive adhesive such as an acrylic pressure-sensitive adhesive is preferably used, which is excellent in optical transparency, exhibits appropriate wettability and pressure-sensitive adhesion properties of a cohesive property and an adhesive property, and is excellent in weather resistance and heat resistance. In particular, an acrylic pressure-sensitive adhesive made of an acrylic polymer containing 4 to 12 carbon atoms is preferred.

In addition to the above, in terms of the prevention of a foaming phenomenon and a peeling phenomenon caused by moisture absorption, the prevention of a degradation in optical properties and bending of a liquid crystal cell caused by thermal expansion difference or the like, and the formation property of a liquid crystal display apparatus which is of high quality and has excellent durability, a pressure-sensitive adhesive layer having a low moisture absorbing ratio and excellent heat resistance is preferred.

The above-mentioned pressure-sensitive adhesive layer may contain, for example, resins of a natural substance or a synthetic substance, in particular, additives to be added to the pressure-sensitive adhesive layer, a tackifying resin, a filler such as glass fibers, glass beads, metal powder, or other inorganic powders, a pigment, a colorant, and an antioxidant.

A pressure-sensitive adhesive layer that contains fine particles and exhibits a light diffusion property or the like may be used.

The above-mentioned pressure-sensitive adhesive layer can be provided by any appropriate method. Examples thereof include a method of preparing a pressure-sensitive adhesive solution in an amount of about 10 to 40% by weight in which a base polymer or a composition thereof is dissolved or dispersed in any appropriate single solvent such as toluene or ethyl acetate or a solvent made of a mixture, and directly applying the pressure-sensitive adhesive solution onto a polarizing plate or an optical film by any appropriate development method such as a flow casting method or a coating method, or forming a pressure-sensitive adhesive layer on a separator according to the above, and moving the pressure-sensitive adhesive layer to the polarizer protective film surface.

The pressure-sensitive adhesive layer may also be provided on one surface or both surfaces of a polarizing plate as superimposed layers of different compositions, different kinds, or the like. In the case of providing the pressure-sensitive adhesive layer on both surfaces of the polarizing plate, pressure-sensitive adhesive layers on front and reverse surfaces of the polarizing plate can have different compositions, kinds, thicknesses, and the like.

The thickness of the pressure-sensitive adhesive layer can be determined appropriately in accordance with the use purpose and the adhesive strength, and preferably 1 to 40 μm, more preferably 5 to 30 μm, and particularly preferably 10 to 25 μm. When the thickness of the pressure-sensitive adhesive layer is smaller than 1 μm, durability of the layer degrades. When the thickness of the pressure-sensitive adhesive layer is larger than 40 μm, lifting and peeling are likely to occur due to foaming or the like, resulting in an unsatisfactory outer appearance.

In order to enhance the contactness between the above-mentioned polarizer protective film and the above-mentioned pressure-sensitive adhesive layer, an anchor layer can also be provided therebetween.

As the anchor layer, preferably, an anchor layer selected from polyurethane, polyester, and polymers containing amino groups in molecules is used, and in particular, polymers containing amino groups in molecules are preferably used. In the polymer containing an amino group in molecules, an amino group in the molecules reacts with a carboxyl group in the pressure-sensitive adhesive or a polar group in a conductive polymer, or exhibits an interaction such as an ion interaction, so satisfactory contactness is ensured.

Examples of the polymers containing amino groups in molecules include polyethyleneimine, polyallylamine, polyvinylamine, polyvinylpyridine, polyvinylpyrrolidine, and a polymer of an amino group-containing monomer such as dimethylaminoethyl acrylate shown in the above-mentioned copolymerized monomer of the acrylic pressure-sensitive adhesive.

In order to provide the above-mentioned anchor layer with an antistatic property, an antistatic agent can also be added. Examples of the antistatic agent for providing an antistatic property include an ionic surfactant, a conductive polymer such as polyaniline, polythiophene, polypyrrole, and polyquinoxaline, and a metal oxide such as tin oxide, antimony oxide, and indium oxide. Particularly, in view of optical properties, an outer appearance, an antistatic effect, and stability of an antistatic effect under heat or humidity, the conductive polymers are used preferably. Of those, a water-soluble conductive polymer such as polyaniline and polythiophene, or a water-dispersion conductive polymer is particularly preferably used. The reason for this is as follows: in the case of using a water-soluble conductive polymer or a water-dispersion conductive polymer as a material for forming an antistatic layer, the deterioration of an optical film base caused by an organic solvent can be suppressed in the process of coating.

In the present invention, each layer of a polarizer and a polarizer protective film forming the above-mentioned polarizing plate, and the pressure-sensitive adhesive layer may be provided with a UV absorbing ability, for example, by the treatment with a UV absorbing agent such as a salicylateester-based compound, a benzophenol-based compound, benzotriazol-based compound, a cyanoacrylate-based compound, and a nickel complex salt-based compound.

The polarizing plate of the present invention may be provided on either one of a viewer side and a backlight side of a liquid crystal cell or on both sides thereof without particular limitation.

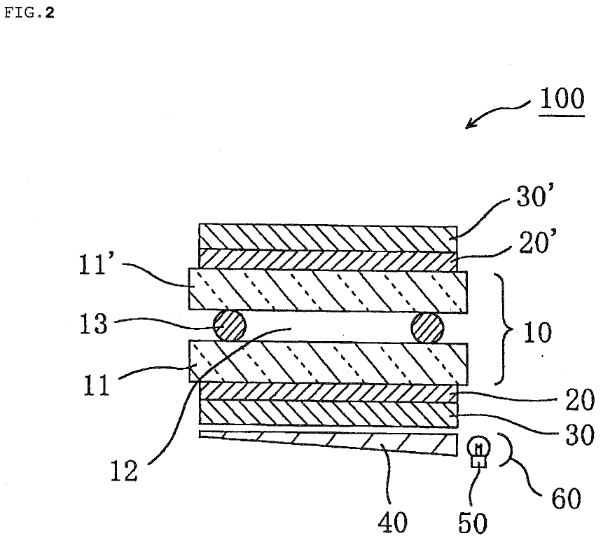

Next, an image display apparatus of the present invention will be described. The image display apparatus of the present invention includes at least one polarizing plate of the present invention. Herein, as one example, a liquid crystal display apparatus will be described. However, it is needless to say that the present invention is applicable to any display apparatus requiring a polarizing plate. Specific examples of the image display apparatus to which the polarizing plate of the present invention is applicable include a self-emitting display apparatus such as an electroluminescence (EL) display, a plasma display (PD), and a field emission display (FED). FIG. 2 is a schematic cross-sectional view of a liquid crystal display apparatus according to a preferred embodiment of the present invention. In the illustrated example, a transmission-type liquid crystal display apparatus will be described. However, it is needless to say that the present invention is also applicable to a reflection-type liquid crystal display apparatus or the like.

A liquid crystal display apparatus 100 includes a liquid crystal cell 10, retardation films 20 and 20′ placed so as to interpose the liquid crystal cell 10 therebetween, polarizing plates 30 and 30′ placed on outer sides of the retardation films 20 and 20′, a light guide plate 40, a light source 50, and a reflector 60. The polarizing plates 30 and 30′ are placed so that polarization axes thereof are perpendicular to each other. The liquid crystal cell 10 includes a pair of glass substrates 11 and 11′ and a liquid crystal layer 12 as a display medium placed between the substrates. One glass substrate 11 is provided with a switching element (typically, TFT) for controlling the electrooptical properties of liquid crystals, a scanning line for providing a gate signal to the switching element, and a signal line for providing a source signal to the switching element (all of them are not shown). The other glass substrate 11′ is provided with a color layer forming a color filter and a shielding layer (black matrix layer) (both of them are not shown). A distance (cell gap) between the glass substrates 11 and 11′ is controlled by a spacer 13. In the liquid crystal display apparatus of the present invention, the polarizing plate of the present invention described above is employed as at least one of the polarizing plates 30 and 30′.

For example, in the case of the liquid crystal display apparatus 100 employing a TN mode, liquid crystal molecules of the liquid crystal layer 12 are aligned in a state with respective polarization axes being shifted by 90° during application of no voltage. In such a state, injected light including light in one direction transmitted through the polarizing plate is twisted 90° by the liquid crystal molecules. As described above, the polarizing plates are arranged such that the respective polarization axes are perpendicular to each other, and thus light (polarized light) reaching the other polarizing plate transmits through the polarizing plate. Thus, during application of no voltage, the liquid crystal display apparatus 100 provides a white display (normally white mode). Meanwhile, in the case where a voltage is applied onto the liquid crystal display apparatus 100, alignment of the liquid crystal molecules in the liquid crystal layer 12 changes. As a result, the light (polarized light) reaching the other polarizing plate cannot transmit through the polarizing plate, and a black display is provided. Displays are switched as described above by pixel by using the active element, to thereby form an image.

### EXAMPLES

Hereinafter, the present invention will be described specifically by way of examples, but the present invention is not limited to these examples. Unless otherwise specified, parts and percents in the examples are based on the weight.

### <Heat Shock Test>

A sample obtained by cutting a polarizing plate into a size of 15 inches was held repeatedly at −40° C. for 30 minutes and 85° C. for 30 minutes alternately, and a light transmittance change amount (%) and a color fading amount (mm) of the end of the sample after 240 hours were measured. The light transmittance of the sample was measured using a high-speed integrating-sphere spectral transmittance meter (DOT-3C (Trade name), manufactured by Murakami Color Research Laboratory Instruments).

### <Hot Water Soaking Test>

A sample obtained by cutting a polarizing plate into a size of 25 mm×50 mm (the long side is parallel to the polarizer absorption axis) was soaked in hot water at 60° C. After 10 hours, the peeling amount (mm) of the end of the sample was measured.

### <Single Axis Transmittance, Polarization Degree>

Sample chips with a size of 5 cm×5 cm were cut out from the polarizing plates produced in the examples and comparative examples, and the single axis transmittance and polarization degree of the sample chips were measured at 23° C., using the high-speed integrating-sphere spectral transmittance meter (DOT-3C (Trade name), manufactured by Murakami Color Research Laboratory Instruments).

### <Rework Test>

A pressure-sensitive adhesion type polarizing plate was produced as follows, and was subjected to a rework test.

### (Formation of a Pressure-Sensitive Adhesive Layer)

A solution (solid content: 30%) containing an acrylic polymer with a weight average molecular weight of 2,000,000 made of a copolymer of butyl acrylate, acrylic acid, and 2-hydroxyethyl acrylate having a weight ratio of 100:5:0.1 was used as a base polymer. To the above acrylic polymer solution, 4 parts of Colonate L (Trade name) manufactured by Nippon Polyurethane Industry Co., Ltd. that is an isocyanate-based polyfunctional compound, 0.5 part of an additive (KBM 403 (Trade name) manufactured by Shin-Etsu Chemical Co., Ltd.), and a solvent (ethyl acetate) for adjusting a viscosity were added with respect to 100 parts of solid content of the polymer, whereby a pressure-sensitive adhesive solution (solid content: 12%) was prepared. The pressure-sensitive adhesive solution was applied to a release film (polyethylene terephthalate base material; DIAFOIL MRF38 (Trade name) manufactured by Mitsubishi Polyester Film Corporation) so that the thickness after drying became 25 μm, and dried with a hot-air circulating oven to form a pressure-sensitive adhesive layer.

### (Polarizing Plate Anchor Layer)

A polyethyleneimine adduct of a polyacrylic ester (Polyment NK380 (Trade name) manufactured by Nippon Shokubai Co., Ltd.) was diluted 50-fold with methyl isobutyl ketone. The resultant adduct was applied to the surfaces on the polymethylmethacrylate layer side of the polarizing plates produced in the examples and comparative examples using a wire bar #5, followed by drying, whereby an anchor layer with the thickness of 50 nm was formed.

### (Production of a Pressure-Sensitive Adhesion Type Polarizing Plate)

A release film with the above pressure-sensitive adhesive layer formed thereon was attached to the anchor layer provided on the above polarizing plate, whereby a pressure-sensitive adhesion type polarizing plate was produced.

### (Rework)

A sample chip with a size of 150 mm×90 mm was cut out from the above pressure-sensitive adhesion type polarizing plate so that the absorption axis of the polarizing plate became 0° in parallel to the long side direction, and the release film was peeled, whereby the pressure-sensitive adhesive layer was attached to a non-alkali glass and treated in an autoclave at 50° C. and 5×10⁵ Pa (5 atm) for 15 minutes. The polarizing plate attached to the glass plate thus obtained was peeled from the glass plate in parallel to the long side direction from the short side of the polarizing plate. The operation was performed three times each for the polarizing plates produced in the examples and the comparative examples, and the presence/absence of peeling at an interface between the polarizer of the polarizing plate and the protective film (a laminated film or a triacetyl cellulose film) was observed. The results of the rework test shown in Table 2 show the number of samples (the number of samples without peeling/3) during the above three times of the operations.

### <Preparation of a Polyvinyl Alcohol-Based Adhesive Aqueous Solution>

An aqueous solution containing 20 parts by weight of methylol melamine with respect to 100 parts by weight of a polyvinyl alcohol resin modified with an acetoacetyl group (acetylation degree: 13%) was adjusted so that the concentration became 0.5% by weight, whereby a polyvinyl alcohol-based adhesive aqueous solution was prepared.

### Example 1

### (a) Production of a Laminated Film (1A)

A polymethyl methacrylate film with a thickness of 40 μm was subjected to a corona discharge treatment (irradiation amount: 50 w/m²/min). Then, a zinc chloride aqueous solution (10% by weight) was applied to the surface subjected to the corona discharge treatment, followed by drying at 85° C. for 5 minutes. Further, a silicone primer solution (3% by weight) was applied to the resultant surface as an undercoating treatment, followed by drying at 70° C. for 10 minutes.

The thickness of each layer of the laminated film (1A) obtained after drying was a polymethyl methacrylate layer/zinc chloride layer/silicone primer layer=40 μm/50 nm/50 nm.

### (b) Production of a Polarizer Film

A polyvinyl alcohol film (VS75RS (Trade name) manufactured by Kuraray Co., Ltd.) was swollen with hot water at 30° C., and dyed in an iodine aqueous solution at 30° C. Further, the polyvinyl alcohol film was cross-linked in a boracic acid aqueous solution (3% by weight) at 40° C., and uniaxially stretched in a boracic acid aqueous solution (5% by weight) at 60° C. After that, the adjustment of a film hue and the washing of a film surface were performed in the water-washing step at 30° C. After water-washing, the polyvinyl alcohol film was dried at 40° C. for 5 minutes to produce a polarizer film (1B).

### (c) Production of a Polarizing Plate (1C)

A triacetyl cellulose film was attached to one surface of the polarizer film (1B) produced in the above section (b), and a silicone primer layer surface of the laminated film (1A) produced in the section (a) was attached to the other surface of the polarizer film (1B) with a polyvinyl alcohol-based adhesive, followed by drying at 80° C. for 10 minutes, whereby a polarizing plate (1C) was produced.

Table 1 shows the results obtained by conducting the heat shock test and the hot water soaking test with respect to the polarizing plate (1C). Table 2 shows the results obtained by conducting the measurement of a single axis transmittance, the measurement of a polarization degree, and the rework test with respect to the polarizing plate (1C).

### Example 2

### (a) Production of a Laminated Film (2A)

A polymethyl methacrylate film with a thickness of 40 μm was subjected to a corona discharge treatment (irradiation amount: 50 w/m²/min). Then, a zinc chloride aqueous solution (10% by weight) was applied to the surface subjected to the corona discharge treatment, followed by drying at 85° C. for 5 minutes. Further, a silicone primer solution (3% by weight) was applied to the resultant surface as an under coating treatment, followed by drying at 70° C. for 10 minutes.

The thickness of each layer of the laminated film (1A) obtained after drying was a polymethyl methacrylate layer/zinc chloride layer/silicone primer layer=40 μm/50 nm/100 nm.

### (b) Production of a Polarizer Film

A polyvinyl alcohol film (VS75RS (Trade name) manufactured by Kuraray Co., Ltd.) was swollen with hot water at 30° C., and dyed in an iodine aqueous solution at 30° C. Further, the polyvinylalcohol film was cross-linked in a boracic acid aqueous solution (3% by weight) at 40° C., and uniaxially stretched in a boracic acid aqueous solution (5% by weight) at 60° C. After that, the adjustment of a film hue and the washing of a film surface were performed in the water-washing step at 30° C. After water-washing, the polyvinyl alcohol film was dried at 40° C. for 5 minutes to produce a polarizer film (2B).

### (c) Production of a Polarizing Plate (2C)

A triacetyl cellulose film was attached to one surface of the polarizer film (2B) produced in the above section (b), and a silicone primer layer surface of the laminated film (2A) produced in the section (a) was attached to the other surface of the polarizer film (2B) with a polyvinyl alcohol-based adhesive, followed by drying at 80° C. for 10 minutes, whereby a polarizing plate (2C) was produced.

Table 1 shows the results obtained by conducting the heat shock test and the hot water soaking test with respect to the polarizing plate (2C). Table 2 shows the results obtained by conducting the measurement of a single axis transmittance, the measurement of a polarization degree, and the rework test with respect to the polarizing plate (2C).

### Example 3

### (a) Production of a Laminated Film (3A)

A polymethyl methacrylate film with a thickness of 40 μm was subjected to a corona discharge treatment (irradiation amount: 50 w/m²/min). Then, a cobalt chloride aqueous solution (10% by weight) was applied to the surface subjected to the corona discharge treatment, followed by drying at 85° C. for 5 minutes. Further, a silicone primer solution (3% by weight) was applied to the resultant surface as an undercoating treatment, followed by drying at 70° C. for 10 minutes.

The thickness of each layer of the laminated film (3A) obtained after drying was a polymethyl methacrylate layer/cobalt chloride layer/silicone primer layer=40 μm/50 nm/50 nm.

### (b) Production of a Polarizer Film

A polyvinyl alcohol film (VS75RS (Trade name) manufactured by Kuraray Co., Ltd.) was swollen with hot water at 30° C., and dyed in an iodine aqueous solution at 30° C. Further, the polyvinyl alcohol film was cross-linked in a boracic acid aqueous solution (3% by weight) at 40° C., and uniaxially stretched in a boracic acid aqueous solution (5% by weight) at 60° C. After that, the adjustment of a film hue and the washing of a film surface were performed in the water-washing step at 30° C. After water-washing, the polyvinyl alcohol film was dried at 40° C. for 5 minutes to produce a polarizer film (3B).

### (c) Production of a Polarizing Plate (3C)

A triacetyl cellulose film was attached to one surface of the polarizer film (3B) produced in the above section (b), and a silicone primer layer surface of the laminated film (3A) produced in the section (a) was attached to the other surface of the polarizer film (3B) with a polyvinyl alcohol-based adhesive, followed by drying at 80° C. for 10 minutes, whereby a polarizing plate (3C) was produced.

Table 1 shows the results obtained by conducting the heat shock test and the hot water soaking test with respect to the polarizing plate (3C). Table 2 shows the results obtained by conducting the measurement of a single axis transmittance, the measurement of a polarization degree, and the rework test with respect to the polarizing plate (3C).

### Comparative Example 1

### (a) Production of a Laminated Film (C1A)

A polymethyl methacrylate film with a thickness of 40 μm was subjected to a corona discharge treatment (irradiation amount: 50 w/m²/min). Then, a silicone primer solution (3% by weight) was applied to the resultant surface as an undercoating treatment, followed by drying at 70° C. for 10 minutes.

The thickness of each layer of the laminated film (C1A) obtained after drying was a polymethyl methacrylate layer/silicone primer layer=40 μm/50 nm.

### (b) Production of a Polarizer Film

A polyvinyl alcohol film (VS75RS (Trade name) manufactured by Kuraray Co., Ltd.) was swollen with hot water at 30° C., and dyed in an iodine aqueous solution at 30° C. Further, the polyvinylalcohol film was cross-linked in a boracic acid aqueous solution (3% by weight) at 40° C., and uniaxially stretched in a boracic acid aqueous solution (5% by weight) at 60° C. After that, the adjustment of a film hue and the washing of a film surface were performed in the water-washing step at 30° C. After water-washing, the polyvinyl alcohol film was dried at 40° C. for 5 minutes to produce a polarizer film (C1B).

### (c) Production of a Polarizing Plate (C1C)

A triacetyl cellulose film was attached to one surface of the polarizer film (C1B) produced in the above section (b), and a silicone primer layer surface of the laminated film (C1A) produced in the section (a) was attached to the other surface of the polarizer film (C1B) with a polyvinyl alcohol-based adhesive, followed by drying at 80° C. for 10 minutes, whereby a polarizing plate (C1C) was produced.

Table 1 shows the results obtained by conducting the heat shock test and the hot water soaking test with respect to the polarizing plate (C1C). Table 2 shows the results obtained by conducting the measurement of a single axis transmittance, the measurement of a polarization degree, and the rework test with respect to the polarizing plate (C1C).

### Comparative Example 2

### (a) Production of a Film (C2A)

A polymethyl methacrylate film with a thickness of 40 μm was subjected to a corona discharge treatment (irradiation amount: 50 w/m²/min) to produce a film (C2A).

### (b) Production of a Polarizer Film

A polyvinyl alcohol film (VS75RS (Trade name) manufactured by Kuraray Co., Ltd.) was swollen with hot water at 30° C., and dyed in an iodine aqueous solution at 30° C. Further, the polyvinylalcohol film was cross-linked in a boracic acid aqueous solution (3% by weight) at 40° C., and uniaxially stretched in a boracic acid aqueous solution (5% by weight) at 60° C. After that, the adjustment of a film hue and the washing of a film surface were performed in the water-washing step at 30° C. After water-washing, the polyvinyl alcohol film was dried at 40° C. for 5 minutes to produce a polarizer film (C2B).

### (c) Production of a Polarizing Plate (C2C)

A triacetyl cellulose film was attached to one surface of the polarizer film (C2B) produced in the above section (b), and a corona discharge treatment surface of the laminated film (C2A) produced in the section (a) was attached to the other surface of the polarizer film (C2B) with a polyvinyl alcohol-based adhesive, followed by drying at 80° C. for 10 minutes, whereby a polarizing plate (C2C) was produced.

Table 1 shows the results obtained by conducting the heat shock test and the hot water soaking test with respect to the polarizing plate (C2C). Table 2 shows the results obtained by conducting the measurement of a single axis transmittance, the measurement of a polarization degree, and the rework test with respect to the polarizing plate (C2C).

TABLE 1

| | Heat shock test | | Hot water |
|---|---|---|---|
| | Light | Color fading | soaking test |
| | transmittance | amount | Peeling amount |
| | change amount (%) | of end (mm) | (mm) |
| Example 1 | 0.15 | 0.3 | 0 |
| Example 2 | 0.17 | 0.3 | 0 |
| Example 3 | 0.20 | 0.3 | 0 |
| Comparative | 0.50 | 0.5 | 5 |
| Example 1 | | | |
| Comparative | 1.30 | 1.0 | 10 |
| Example 2 | | | |

TABLE 2

| | Single axis | Polarization | |
|---|---|---|---|
| | transmittance (%) | degree (%) | Rework test |
| Example 1 | 43.5 | 99.97 | 3/3 |
| Example 2 | 43.4 | 99.97 | 3/3 |
| Example 3 | 43.6 | 99.97 | 3/3 |
| Comparative | 43.5 | 99.97 | 1/3 |
| Example 1 | | | |
| Comparative | 43.5 | 99.97 | 0/3 |
| Example 2 | | | |

In Examples 1 to 3, the light transmittance change amount and color fading amount of the end in the heat shock test were both smaller and the peeling amount in the hot water soaking test was smaller, compared with those in Comparative Examples 1 to 2, and no peeling between the polarizer and the protective film was recognized in the rework test.

### INDUSTRIAL APPLICABILITY

The polarizing plate of the present invention can be preferably used for various kinds of image display apparatuses (liquid crystal display apparatus, organic EL display apparatus, PDP, etc.).

1. A polarizing plate comprising:
a polarizer formed of a polyvinyl alcohol-based resin;
an adhesive layer;
a metal salt layer; and
a polarizer protective film in the stated order.

2. A polarizing plate according to claim 1, wherein the adhesive layer is formed of a polyvinyl alcohol-based adhesive.

3. A polarizing plate according to claim 1, wherein the metal salt layer is formed of at least one kind selected from a zinc salt and a cobalt salt.

4. A polarizing plate according to claim 1, wherein the polarizer protective film contains a (meth)acrylic resin layer.

5. A polarizing plate according to claim 1, further comprising as at least one of an outermost layer a pressure-sensitive adhesive layer.

6. An image display apparatus, comprising at least one of the polarizing plate according to claim 1.

7. A polarizing plate according to claim 2, wherein the metal salt layer is formed of at least one kind selected from a zinc salt and a cobalt salt.

8. A polarizing plate according to claim 2, wherein the polarizer protective film contains a (meth)acrylic resin layer.

9. A polarizing plate according to claim 3, wherein the polarizer protective film contains a (meth)acrylic resin layer.

10. A polarizing plate according to claim 7, wherein the polarizer protective film contains a (meth)acrylic resin layer.

11. A polarizing plate according to claim 2, further comprising as at least one of an outermost layer a pressure-sensitive adhesive layer.

12. A polarizing plate according to claim 3, further comprising as at least one of an outermost layer a pressure-sensitive adhesive layer.

13. A polarizing plate according to claim 4, further comprising as at least one of an outermost layer a pressure-sensitive adhesive layer.

14. A polarizing plate according to claim 7, further comprising as at least one of an outermost layer a pressure-sensitive adhesive layer.

15. A polarizing plate according to claim 8, further comprising as at least one of an outermost layer a pressure-sensitive adhesive layer.

16. A polarizing plate according to claim 9, further comprising as at least one of an outermost layer a pressure-sensitive adhesive layer.

17. A polarizing plate according to claim 10, further comprising as at least one of an outermost layer a pressure-sensitive adhesive layer.

18. An image display apparatus, comprising at least one of the polarizing plate according to claim 2.

19. An image display apparatus, comprising at least one of the polarizing plate according to claim 3.

20. An image display apparatus, comprising at least one of the polarizing plate according to claim 4.
